(19) United States
(12) Patent Application Publication
(10) Pub. No.: US 2008/0272612 A1
(43) Pub. Date: Nov. 6, 2008

(54) Covering Device for Glazing in a Vehicle

(75) Inventors: Bernhard Harnischfeger, Dachau (DE); Wolfgang Suess, Freising (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/575,663

(22) PCT Filed: Sep. 16, 2005
(86) PCT No.: PCT/DE2005/001627

§ 371 Date: Mar. 21, 2007

(30) Foreign Application Priority Data
Sep. 21, 2004 (DE) 10 2004 045 726.3

(51) Int. Cl. B60J 3/00

(52) U.S. Cl. 296/97.9; 296/216.01

(57) ABSTRACT

A cover device for vehicle glazing (12), especially a transparent sliding roof cover (12), has a flat, flexible darkening element (12) which can be drawn over the vehicle glazing (12). On its end which is the front in the drawing direction, the darkening element (20) is connected to a pull element (22) which extends transversely relative to the drawing direction. On its end which faces away from the pull element (22), the darkening element (20) is joined permanently to the vehicle. Moreover, the darkening element (20) is deflected over a tension element (26) which extends transversely to the drawing direction and which is pretensioned against the drawing direction. To prevent rippling and the formation of folds, the darkening element (20) is guided at its side edge regions on the tension element (26).

### BACKGROUND OF THE INVENTION

1. Field of the Invention

The invention relates to a cover device of vehicle glazing, especially a transparent sliding roof cover, having a flat, flexible darkening element which can be drawn over the vehicle glazing, the front end of which is connected to a pull element which extends transversely to the drawing direction, on its end facing away from the pull element is joined permanently to the body and is deflected on a tension element which extends transversely to the drawing direction and which is pretensioned counter to the drawing direction.

2. Description of Related Art

A cover device of the above-mentioned type is known from German Utility Model DE 296 19 210 U1 and constitutes a darkening means by which the vehicle glazing can be darkened. The known device comprises a flat, flexible darkening element which can be drawn over the vehicle glazing and in the retracted state is held by a housing. The darkening element is fixed on the vehicle in a housing on one end and on its front end in the drawing direction is provided with a drawbar which can be suspended on a structural or lining element which is assigned to the vehicle to secure the darkening element in the desired drawing position. Furthermore, the darkening element is deflected on a so-called pull-back rod so that, in the housing, it has two regions which are aligned essentially planar parallel to one another, with a size which changes depending on the drawing position. The pull-back rod is pretensioned by means of a pull-back element which is made as a spring element which is tensioned counter to the drawing direction so that the part of the darkening element emerging from the housing is always kept tensioned.

However, the darkening element of the known cover device cannot be made arched, as can be required in darkening elements for transparent sliding roof covers, without the darkening element being folded or rippled as a result of the forces which act in the direction of the center axis of the darkening element which faces in the drawing direction.

Furthermore, sliding headliners, stacking headliners, and shades are used as darkening systems for transparent sliding roof covers. The sliding headliner can be an element which is arched in the normal direction. The stacking headliner can also be made as a transversely arched element. The shade which is used essentially in large roof systems generally constitutes a flat element in the drawn state. The disadvantage of the sliding headliner is that, in so-called large roof systems which are provided with a large openable region, it may be that it cannot be used since the entire length of the sliding headliner would have to be accommodated by a corresponding cavity in the roof region. This installation space may possibly not be available. The stacking headliner has the disadvantage that it requires a large installation space in the vertical direction. The stacking headliner must also be provided with a possibly complex stacking mechanism. In a shade which is provided with a take-up tube and a flexible darkening element which can be rolled onto it, there is the disadvantage that, in the region of the take-up tube with the darkening element rolled up, it has a large requirement for installation space in the vertical direction, and moreover, transverse arching of the darkening element cannot be easily obtained. Also, an additional roll-off edge must be provided to ensure defined gap formation relative to a stationary headliner element.

### SUMMARY OF THE INVENTION

The object of the invention is to devise a darkening element which can be used especially in the region of the sliding roof of a motor vehicle with a transparent cover element, which has a small space requirement at a right angle to the plane of the darkening element, and in the drawn state can be provided with an arched darkening element.

This object is achieved by providing a device of the initially mentioned type with a darkening element, the side edge regions of which are guided on the tension element

The heart of the invention is that a nonpositive connection between the darkening element in its transverse direction and the tensioning element is formed at the side edge regions of the darkening element.

The darkening element can be formed from a fabric, a knit, a film, a composite material or the like and is provided with a pull element, like on the end of a shade which is the forward end in the drawing direction. On its end facing away from the pull element, the darkening element is attached to a fastening element which is intended especially for this purpose, or to some other vehicle component, for example, a body part or a lining part, a roof element, a glass element, a gutter or the like.

The tension element, which is pretensioned counter to the drawing direction, keeps the darkening element permanently under tension between the pull element and the fastening element, a defined gap relative to the vehicle-mounted lining part being formed which borders a holding space for the retracted darkening element, which space can be bordered by the outer roof skin in the region of the vehicle roof. The required tension force is applied to the tension element by a spring means which is used as a clamp clip.

The concept “vehicle glazing’ is used to mean vehicle components which are transparent, at least in regions, and which can be made both of glass and of plastic.

In one embodiment of the device which can be implemented with simple means, in accordance with the invention, the darkening element has a thickened region in each of its side edge regions which engages a guide groove of the tension element.

The thickened regions of the darkening element which extend parallel to its drawing direction are formed, in one special embodiment of the device in accordance with the invention, from a cord or the like which is incorporated into the darkening element. The cords can each be sewn into a bracket which is formed by turning down the darkening element at its pertinent side edge region.

The darkening element of the device in accordance with the invention can have an arch which, for example, follows the shape of the associated vehicle glazing. This arch can be dictated, at least in part, by a tension element which is bent transversely relative to the drawing direction. Due to the lateral guidance of the darkening element, in this embodiment, when the darkening element is actuated, i.e., drawn or retracted, the material which forms the darkening element does not ripple and/or form folds. The pull element to which the darkening element is directly attached is provided, in this case, in general, with a bend which is made transversely relative to the drawing direction. For the arched embodiment of the darkening element, the material which forms the darkening element is therefore positively connected in its side edge regions to the tension element such that pulling in the direction of the lengthwise center axis of the flexible material is stopped on the bottom of the tension element.

The pretensioning of the tension element counter to the drawing direction can be implemented in different ways. Preferably, the spring element, however, for reasons of installation space, can also be formed from a so-called volute spring which especially surrounds an optionally bent rod and acts on a spool for a cord which is attached to the tensioning element. Alternatively, the tension element can however also be pretensioned against the drawing direction by means of a directly acting tension spring or compression spring.

In order to ensure clean guidance of the tension element when the darkening element is actuated, the tension element can be provided on its side edges with a respective sliding element which is guided in a corresponding guide rail. The pull element can also be guided in these guide rails. These guide rails can be necessary especially when using the device in accordance with the invention in the region of the vehicle roof.

In general, actuation of the device in accordance with the invention takes place mechanically. The desired drawing direction of the darkening element can be safeguarded by suspending the pull element on a catch means which can be provided in the region of the guide rails. Alternatively however, there can also be an electrical actuation means which preferably acts on the pull element.

Other advantages and advantageous embodiments of the subject matter of the invention are explained in detail below in conjunction with the accompanying drawings in which embodiments of the device in accordance with the invention are shown schematically simplified.

### BRIEF DESCRIPTION OF THE DRAWINGS

FIG. 1 is a lengthwise section through a portion of a vehicle roof with a cover device;

FIG. 2 is a perspective top view of the cover device shown in FIG. 1;

FIG. 3 is a perspective top view of a tension bow of the darkening device together with a darkening element;

FIG. 4 separately shows the tension bow and the darkening element;

FIG. 5 shows a tension means for the tension bow in the region X in FIG. 2;

FIG. 6 shows an alternative embodiment of a tension means; and

FIG. 7 shows another alternative embodiment of the tension means.

### DETAILED DESCRIPTION OF THE INVENTION

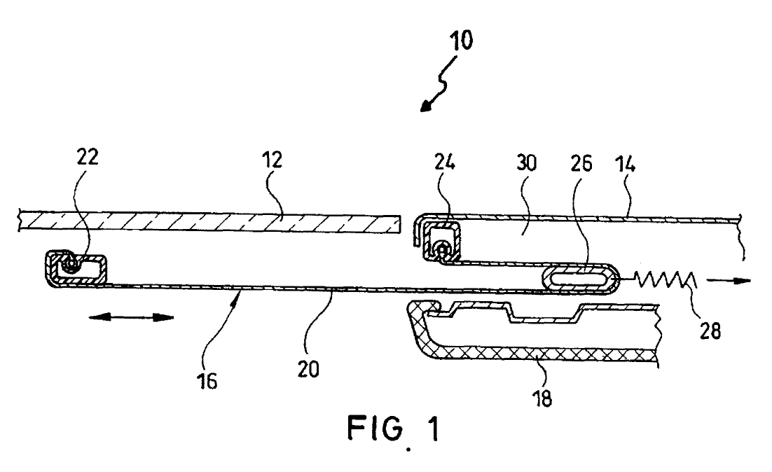

FIG. 1 shows the roof structure 10 of a passenger car which is made with a sliding roof, of which, in this case, only a transparent cover element 12 is shown which, in the closed state, is connected to the body-mounted roof region of the outside skin 14 of the vehicle.

To cover or darken the cover element 12, which is made of glass or plastic, there is a device 16 which can screen the cover 12 in the drawn position, or in the retracted state, can be located in a holding space 30 between the roof region 14 and a fixed headliner 18. The device 16 comprises a flat and flexible darkening element 20 which is formed from a composite film or material, and which is connected to a so-called pull 22 on its front end. The pull 22 stretches the darkening element 20 on its front end in the transverse direction. On its end facing away from the pull 22, the darkening element 20 is fixed on a strip-like fastening element 24 which is made to be mounted on the vehicle. The fastening element 24 can, for example, be part of a roof frame, a part of a body shell or a glass element for a continuous glass roof.

Within the holding space 30 which is located between the outer roof skin 14 and the fixed headliner 18, the darkening element 20 is deflected in a U-shape in the region between the pull 22 and the fastening element 24 on a so-called tension bow 26 so that it has two regions which are aligned essentially parallel to one another. In the holding space 30 the darkening element 20 is therefore made in two layers. The installation space necessary in the holding space 30 in the plane of the darkening element 20 corresponds at most to half the drawing length of the darkening element 20. The minimally required height of the holding space 30 corresponds to twice the thickness of the darkening element 20 plus the height of the tension bow 26 which can be made very flat.

The tension bow 26 is essentially a tubular component with an oval cross section which is pretensioned by means of a spring-like tension means 28 in the opening direction of the darkening device 16, as indicated in FIG. 1 using an arrow. Thus, the darkening element 20, formed from a film, is always kept tensioned.

The pull 22 and the tension bow 26 are each curved upward in the vertical direction so that the darkening element 20 is arched and follows the shape of the roof of the vehicle.

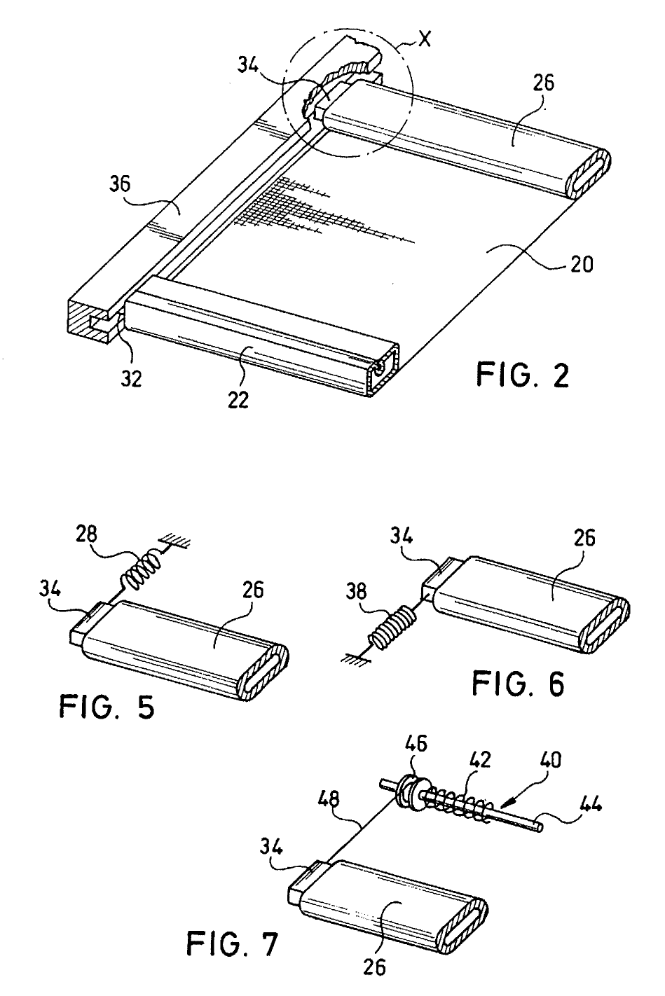

As can be seen in FIG. 2, the pull 22 and the tension bow 26 have a respective sliding element 32, 34 on each of their ends. The sliding elements 32, 34 are guided in a vehicle-mounted guide rail 36 which is located laterally next to the darkening element 20, and which elements can be integrated in a roof frame for the sliding roof. The pull 22 can be variably fixed in the region of the guide rails 36 for fixing the drawing position of the darkening element 20 on a catch means which is not explained in further detail.

The pretensioning of the tension bow 26, as can be taken especially from FIG. 5, is produced by the tension springs which form the tension means 28, of which a respective one acts on each of the two lateral sliding elements 34 of the tension bow. With their front ends, the tension springs are connected to the respective sliding element 34. On their back ends, the tension springs are fixed permanently on the vehicle.

Alternatively, as can be taken from FIG. 6, instead of tension springs, compression springs 38 can also be used as the tension means which are joined permanently to the vehicle with their front ends and with their back ends each act on a respective one of the sliding elements 34 of the tension bow 26.

In another alternative embodiment which is shown in FIG. 7, there can be a tension means 40 which comprises a coil torsion spring 42 which surrounds a rod 44 which is bent according to the arch of the outer roof skin 14 and acts on a cable roller 46 onto which a cable 48, which is connected to the respective sliding element 34 of the tension bow 26, is wound. There can be one tension means 40 of this type for the two sliding elements 34 of the tension bow 26.

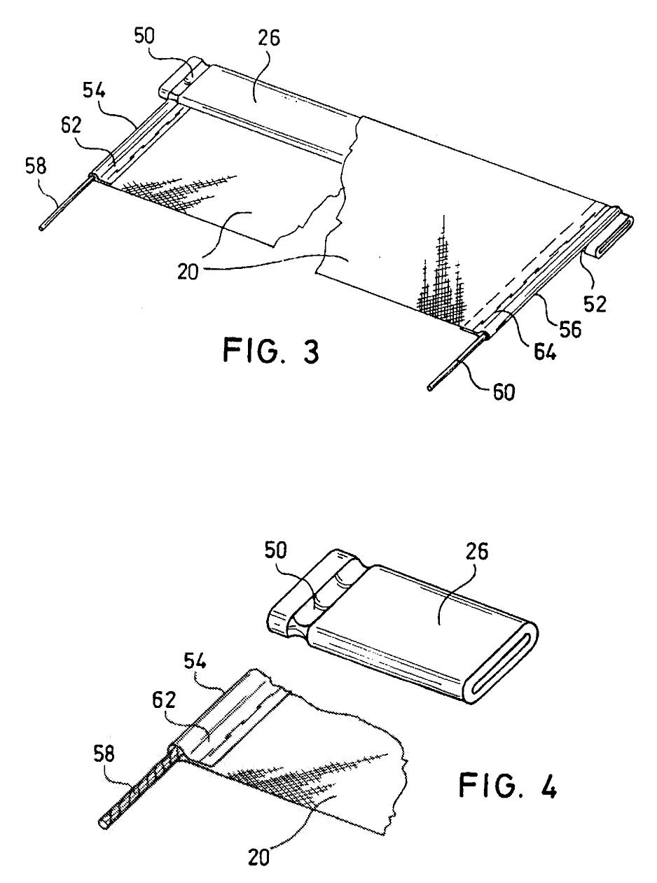

As can be taken especially from FIGS. 3 & 4, the tension bow 26 has a peripheral groove 50, 52 on each of its side edge regions, which is positively engaged by a respective thickened part 54, 56 of the darkening element 20 which extends in the lengthwise direction of the vehicle. This counteracts the force which results by the bending of the tension bow 26, which acts in the direction of the center plane of the vehicle and which could otherwise cause rippling or folding of the darkening element 20.

The thickened areas 54, 56 are each formed by a cord 58, 60 that is fastened in a respective edge bracket 62, 64 of the darkening element 20, such as by the side edge the darkening element 20 being folded over the cord and sewn onto the adjoining area of the material the darkening element 20.

1-8. (canceled)

9. Cover device for vehicle glazing, comprising:
a flat, flexible darkening element, which is connected, in an installed state in a vehicle, to a body portion of the vehicle at a first end and which can be drawn over the vehicle glazing,
a pull element connected to an opposite second end of the darkening element which is the front in a direction in which the darkening element is drawn over the vehicle glazing, the pull element extending transverse to the drawing direction, and
a tension element over which an end of the darkening element facing away from the pull element is deflected, the tension element extending transverse to the drawing direction and being pretensioned in a direction counter to the drawing direction,
wherein the darkening element is guided on the tension element at its side edge regions.

10. Cover device as claimed in claim 9, wherein each of the side edge regions of the darkening element has a respective thickened region which engages a guide groove of the tension element.

11. Cover device as claimed in claim 10, wherein the thickened regions are formed by a cord which is incorporated into the darkening element.

12. Cover device as claimed in claim 9, wherein the darkening element has an arch which is produced, at least in part, by a bend in the tension element.

13. Cover device as claimed in claim 9, wherein the tension element is pretensioned by a spring tension means.

14. Cover device as claimed in claim 9, wherein the spring-like tension means comprises a torsion coil spring which acts on a cable roll which is connected to the tension element.

15. Cover device as claimed in claim 9, wherein the tension element is provided with a slide element on each of opposite ends thereof, the slide element being guided in a guide rail.

16. Cover device as claimed in claim 9, wherein said first end of the darkening element is held, in an installed state in a vehicle, in a cavity which is located between a body mounted headliner element and an outer skin of the vehicle.

17. Cover device as claimed in claim 9, comprising an electrical actuation means which acts on the pull element for drawing the darkening element.

18. Cover device as claimed in claim 9, wherein the glazing is a transparent sliding roof cover.

19. A motor vehicle roof, comprising:
a fixed roof skin of a vehicle,
a transparent sliding roof cover mounted in said fixed roof skin, and
a flat, flexible darkening element which is connected to the fixed roof skin at a first end and which can be drawn over the transparent sliding roof cover,
a pull element connected to an opposite second end of the darkening element which is the front in a direction in which the darkening element is drawn over the transparent sliding roof cover, the pull element extending transverse to the drawing direction, and
a tension element over which an end of the darkening element facing away from the pull element is deflected, the tension element extending transverse to the drawing direction and being pretensioned in a direction counter to the drawing direction,
wherein the darkening element is guided on the tension element at its side edge regions.

20. A motor vehicle roof as claimed in claim 19, wherein said first end of the darkening element is held in a cavity which is located between a body mounted headliner element and the fixed roof skin.

21. A motor vehicle roof as claimed in claim 19, wherein each of the side edge regions of the darkening element has a respective thickened region which engages a guide groove of the tension element.

22. A motor vehicle roof as claimed in claim 21, wherein the thickened regions are formed by a cord which is incorporated into the darkening element.

23. Cover device as claimed in claim 19, wherein the darkening element has an arch which is produced, at least in part, by a bend in the tension element.

24. Cover device as claimed in claim 19, wherein the tension element is pretensioned by a spring tension means.
